(19) United States
(12) Patent Application Publication
(10) Pub. No.: US 2011/0022765 A1
(43) Pub. Date: Jan. 27, 2011

(54) SYSTEM, METHOD, AND COMPUTER PROGRAM PRODUCT FOR MAINTAINING A DIRECT CONNECTION BETWEEN AN INITIATOR AND A DRIVE

(76) Inventor: Ross John Stenfort, Los Altos, CA (US)

Correspondence Address: SANDFORCE, INC.;Attention: Earl Cohen, 12950 Saratoga Ave, Saratoga, CA, 95070-4658, US

(21) Appl. No.: 12/508,259

(22) Filed: Jul. 23, 2009

(51) Int. Cl. G06F 13/14

(52) U.S. Cl. 710/305

(57) ABSTRACT

A system, method, and computer program product are provided for maintaining a direct connection between an initiator and a drive. In operation, a connection is established between an initiator and a drive. Additionally, the connection is determined to be a direct connection between the initiator and the drive. Further, the established direct connection is maintained between the initiator and the drive, such that the established direct connection remains open for information transfer.

### FIELD OF THE INVENTION

The present invention relates to storage systems, and more particularly to maximizing the efficiency in which devices within such storage system communicate.

### BACKGROUND

Computer data storage typically refers to computer components, devices, and recording media that retain digital data used for computing. Computer data storage generally includes memory. Memory may refer to a form of semiconductor storage known as random access memory (RAM) and sometimes other forms of fast but temporary storage.

Similarly, storage systems such as hard disk drives (HDDs) include memory. Additionally, a solid-state drive (SSD) is a data storage device that uses solid-state memory to store persistent data. In some systems, an SSD may emulate a hard disk drive interface.

In storage systems, it is desired to maximize performance. For example, it is often desirable to maximize the efficiency in which devices within such storage system communicate. However, in some cases, establishing connections within such systems is inefficient. There is thus a need for addressing these and/or other issues associated with the prior art.

### SUMMARY

A system, method, and computer program product are provided for maintaining a direct connection between an initiator and a drive. In operation, a connection is established between an initiator and a drive. Additionally, the connection is determined to be a direct connection between the initiator and the drive. Further, the established direct connection is maintained between the initiator and the drive, such that the established direct connection remains open for information transfer for an extended period of time.

### BRIEF DESCRIPTION OF THE DRAWINGS

FIG. 1 shows a method for maintaining a direct connection between an initiator and a drive, in accordance with one embodiment.

FIG. 2A shows a system for maintaining a direct connection between an initiator and a drive, in accordance with one embodiment.

FIG. 2B shows a system for maintaining a direct connection between an initiator and a drive, in accordance with another embodiment.

FIG. 3 shows a method for maintaining a direct connection between an initiator and a target, in accordance with another embodiment.

FIG. 4 illustrates an exemplary system in which the various architecture and/or functionality of the various previous embodiments may be implemented.

### DETAILED DESCRIPTION

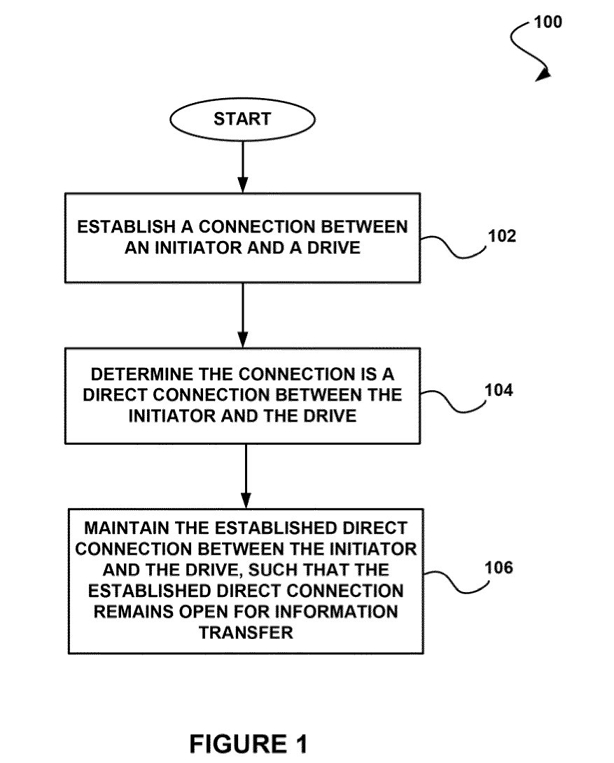

FIG. 1 shows a method 100 for maintaining a direct connection between an initiator and a drive, in accordance with one embodiment. As shown, a connection is established between an initiator and a drive. See operation 102.

In the context of the present description, an initiator refers to any host bus adapter (HBA) capable of sending or receiving information to a host system (e.g. a computer, etc.) or a storage device (e.g. a drive, etc.). In various embodiments, the initiator may be associated with a Serial ATA (SATA) protocol, a Serial Attached SCSI (SAS) protocol, a Fibre Channel (FC) protocol, a Universal Serial Bus (USB) protocol, and/or any various other protocols.

The drive may include any device capable of storing data. For example, in one embodiment, the drive may include a SAS drive. In various other embodiments, the drive may include, but is not limited to, a SATA drive, an FC drive, or a USB drive, and/or any other storage device or drive. As an option, the drive may follow SCSI command protocol. As another option, the drive may follow a protocol tunneled through SAS.

Additionally, the connection is determined to be a direct connection between the initiator and the drive. See operation 104. It may be determined that the connection is a direct connection in a variety of ways.

For example, in one embodiment, determining the connection is a direct connection between the initiator and the drive may include utilizing identify frame data to determine the connection is a direct connection. In this case, the identify frame data may include indentify frame data associated with an out of band (OOB) communication. In another embodiment, determining the connection is a direct connection between the initiator and the drive may include utilizing a SCSI mode page to determine the connection is a direct connection. As an option, the direct topology may also be based on discovering the topology and the association between drives and initiators.

Further, the established direct connection is maintained between the initiator and the drive, such that the established direct connection remains open for information transfer. See operation 106. In one embodiment, maintaining the established direct connection between the initiator and the drive may be based on a mode.

As an option, the mode may be based on identify frame data. As another option, the mode may be based on a SCSI mode page. As yet another option, the mode may be a default mode. In this case, maintaining the established direct connection between the initiator and the drive may occur whenever a direct connection is determined. In another embodiment, the mode may be based on topology discovered.

It should be noted that the established direct connection between the initiator and the drive may be maintained in a variety of ways. For example, in one embodiment, maintaining the established direct connection between the initiator and the drive may include establishing the connection such that timeouts associated with the connection are prohibited, the timer counts are increased to values in disagreement with the standards, or the behavior is altered. In another embodiment, maintaining the established direct connection between the initiator and the drive may include prohibiting a closing of the established direct connection. It should be noted that, in one embodiment, this may be implemented as connections are still open and closed, but at a significantly reduced frequency due to reprogramming the timers or creating new rules for the timers.

It should also be noted the initiator and the drive may include any type of initiator and drive capable of forming a direct connection. In one embodiment, the drive and the initiator may be positioned on the same card. In this case, the card may include a PCI Express based card.

In one embodiment, the initiator may establish the connection between the initiator and the drive. The established direct connection may remain open for information transfer between the initiator and the drive. The information may include data, commands, status, or control information, etc.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

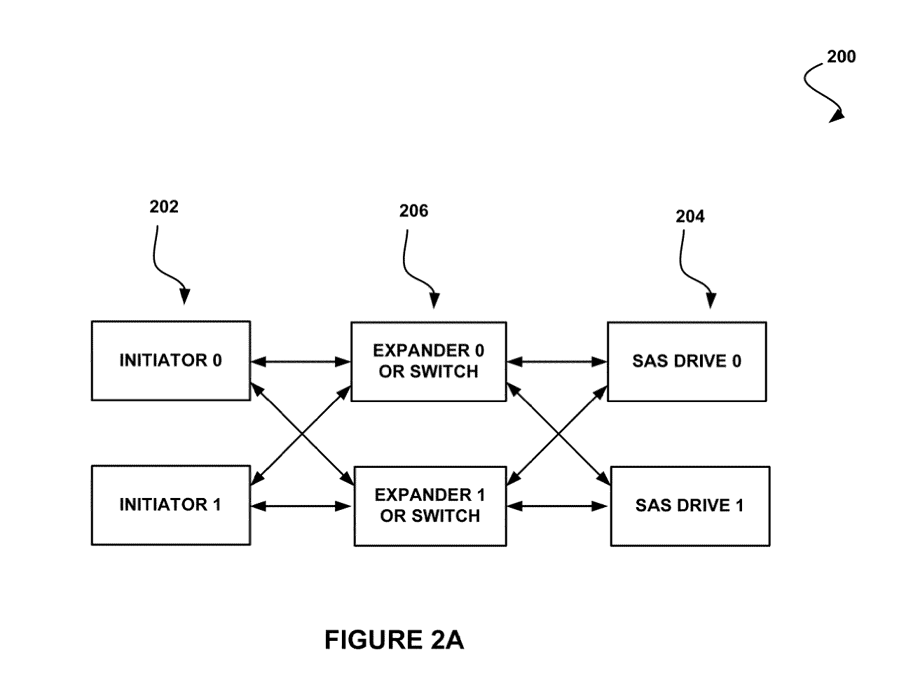

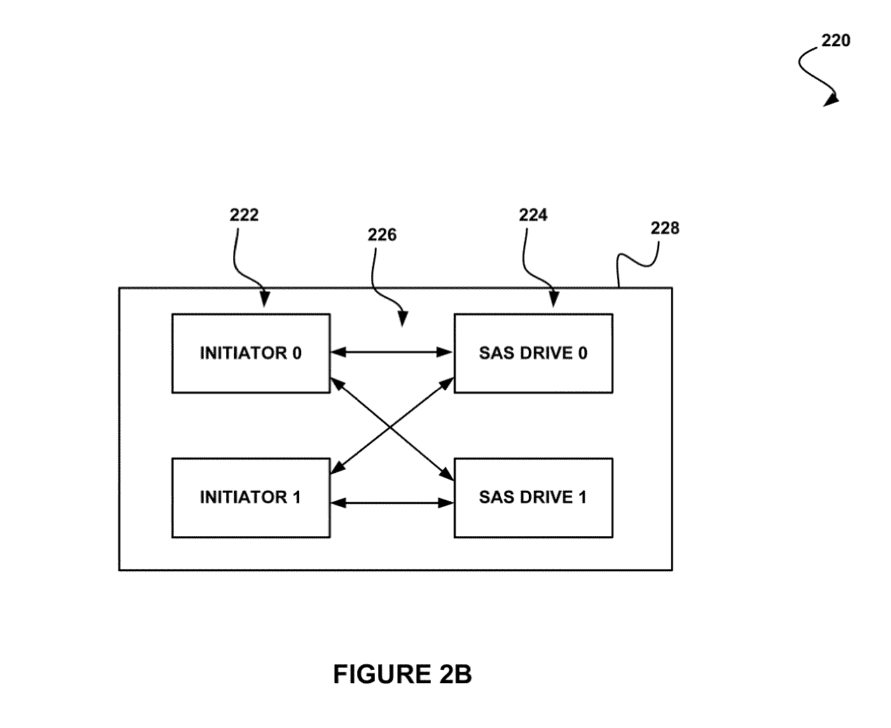

FIG. 2A shows a system 200 for maintaining a direct connection between an initiator and a drive, in accordance with one embodiment. As an option, the present system 200 may be implemented to carry out the method 100 of FIG. 1. Of course, however, the system 200 may be implemented in any desired environment. It should also be noted that the aforementioned definitions may apply during the present description.

As shown, the system 200 includes one or more initiators 202. Additionally, the system includes one or more drives 204. As shown further, one or more expanders or switches 206 may be in communication with the initiators 202 and the drives 204.

The initiators 202 are directly coupled to drives 204 by a direct connection through the one or more expanders or switches 206. It should be noted that the direct connection may also include any suitable interface (e.g. a bus, etc.). In operation, the initiators 202 may establish a connection between the initiators 202 and the drives 204.

The initiators 202, logic associated with the initiators 202, or any other logic, may then be utilized for determining whether the connection is a direct connection between the initiator 202 and the drive 204. If it is determined that the connection is a direct connection, the established direct connection between the initiator 202 and the drive 204 is maintained such that the established direct connection remains open for information transfer. In this case, the initiators 202, logic associated with the initiators 202, or any other logic, may then be utilized for maintaining the established direct connection between the initiators 202 and the drives 204.

As shown in FIG. 2A, the drives 204 may include SAS drives. In SAS based systems and other storage systems, it is often desirable to maximize performance of the drives and associated hardware. In a SAS system, an initiator will typically establish a connection with a target. Once a connection is established, the initiator will generally transfer information.

If the SAS drive is directly connected to an initiator, then any connection open or close overhead is potentially wasted bandwidth. This is because, in these cases, there will not likely ever be any other drives connected to the initiator or drive.

In these cases, when there is a direct connection between an initiator and a target (e.g. a drive, etc.), the connection between the initiator and the target may be maintained such that the connection is never closed. For example, in one embodiment, such technique may be implemented on a PCI Express based card that has drives directly connected to an initiator. In this case, the drives and initiators may exist on the same card.

In one embodiment, the maintenance of the direct connection may be based on a mode. As an option, the identify frame data at the end of an OOB may be used to identify this condition and enable this mode. As another option, this mode may be enabled using a SCSI mode page or other techniques.

FIG. 2B shows a system 220 for maintaining a direct connection between an initiator and a drive, in accordance with one embodiment. As an option, the present system 220 may be implemented in the context of the functionality and architecture of FIGS. 1-2A. Of course, however, the system 220 may be implemented in any desired environment. Additionally, the aforementioned definitions may apply during the present description.

As shown, the system 220 includes one or more initiators 222. Additionally, the system includes one or more drives 224. As an option, the initiators 222 and the drives 224 may be positioned on a card 228. In one embodiment, the card 228 may include a PCI Express based card.

The initiators 222 are directly coupled to drives 224 by a direct connection 226. It should be noted that the direct connection 226 may include any suitable interface (e.g. a bus, etc.). in operation, the initiators 222 may establish a connection between the initiators 222 and the drives 224.

The initiators 222, logic associated with the initiators 222, or any other logic, may then be utilized for determining whether the connection is a direct connection between the initiator 222 and the drive 224. If it is determined that the connection is a direct connection, the established direct connection between the initiator 222 and the drive 224 is maintained such that the established direct connection remains open for information transfer. In this case, the initiators 222, logic associated with the initiators 222, or any other logic, may then be utilized for maintaining the established direct connection between the initiators 222 and the drives 224.

As shown in FIG. 2B, the number of initiator links may be greater than or equal to the number of SAS drives 224. Thus, the initiators 222 may have open connections to all the drives 224 at the same time. In one embodiment, additional drives may be used for failover such that if one drive fails, then the additional drives may be used to rebuild. Accordingly, the number of active drives may still be based on the number of initiator links, but with more drives present. The connections may still always be open in this case.

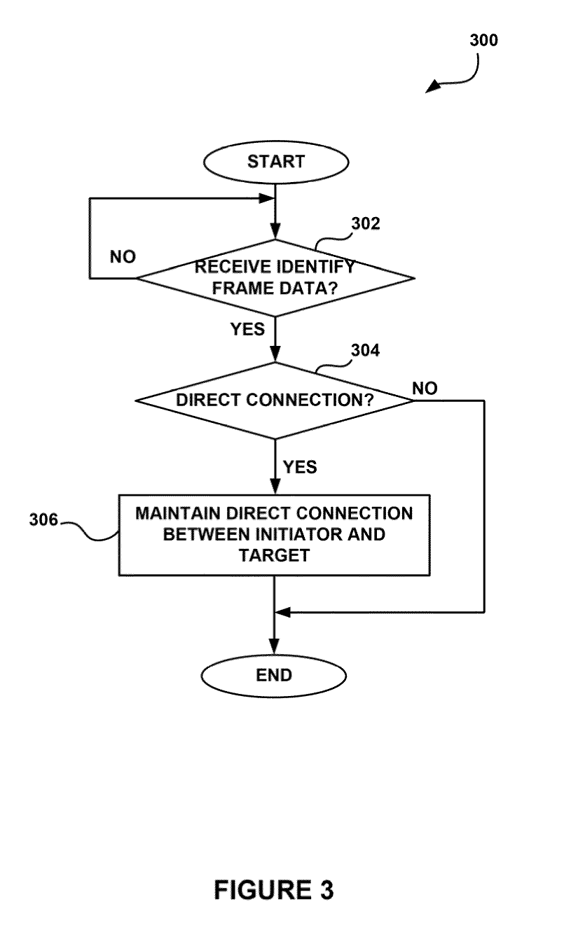

FIG. 3 shows a method 300 for maintaining a direct connection between an initiator and a target, in accordance with another embodiment. As an option, the present method 300 may be implemented in the context of the functionality and architecture of FIGS. 1-2B. Of course, however, the method 300 may be carried out in any desired environment. Again, the aforementioned definitions may apply during the present description.

As shown, it is determined whether identify frame data is received. See operation 302. In one embodiment, the identify frame data may include indentify frame data associated with an OOB communication.

If identify frame data is received, it is determined whether a direct connection sexists between an initiator and a target. See operation 304. In this case, the target may include any device capable of communicating with the initiator (e.g. a drive, etc.).

If it is determined that a direct connection exists between the initiator and the target, the direct connection between the initiator and the target is maintained. See operation 306. It should be noted that, in one embodiment, this may be performed only in a specific mode.

As an option, the mode may be based on identify frame data. As another option, the mode may be based on a SCSI mode page. As yet another option, the mode may be a default mode.

In another embodiment, this maybe a permanent operation. In this case, maintaining the direct connection between the initiator and the target may occur whenever a direct connection is determined.

The maintaining of the connection may occur in various ways. For example, in one embodiment, the direct connection between the initiator and the target may be maintained by prohibiting timeouts associated with the connection. In another embodiment, the direct connection between the initiator and the target may be maintained by prohibiting a closing of the direct connection.

It should be noted that, although in FIG. 3, determining whether the connection is a direct connection between the initiator and the target includes utilizing identify frame data, in another embodiment, determining the connection is a direct connection between the initiator and the target may include utilizing a SCSI mode page.

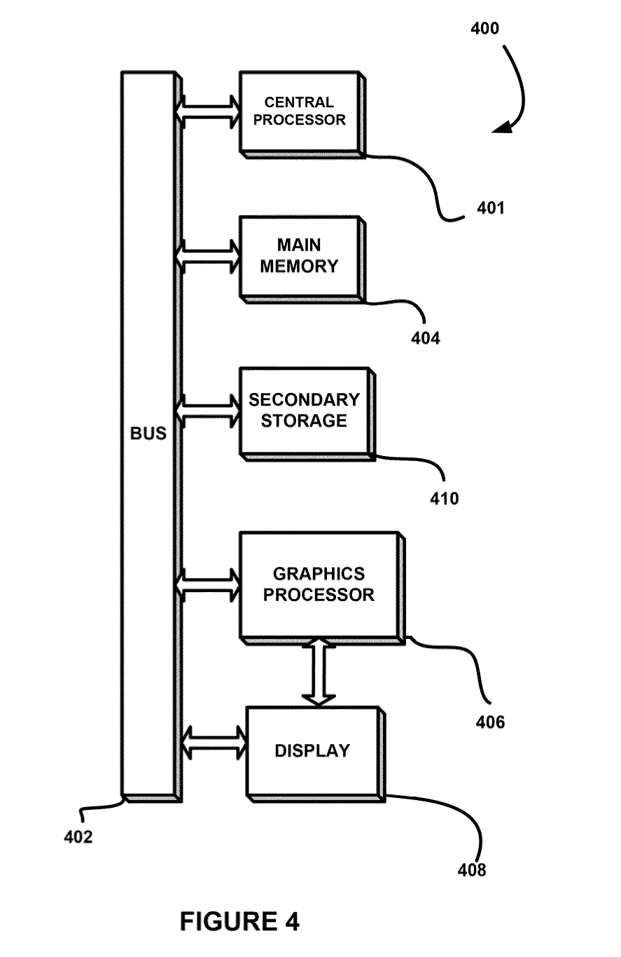

FIG. 4 illustrates an exemplary system 400 in which the various architecture and/or functionality of the various previous embodiments may be implemented. As shown, a system 400 is provided including at least one host processor 401 which is connected to a communication bus 402. The system 400 also includes a main memory 404. Control logic (software) and data are stored in the main memory 404 which may take the form of random access memory (RAM).

The system 400 also includes a graphics processor 406 and a display 408, i.e. a computer monitor. In one embodiment, the graphics processor 406 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 400 may also include a secondary storage 410. The secondary storage 410 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 404 and/or the secondary storage 410. Such computer programs, when executed, enable the system 400 to perform various functions. Memory 404, storage 410 and/or any other storage are possible examples of computer-readable media.

In one embodiment, the architecture and/or functionality of the various previous figures may be implemented in the context of the host processor 401, graphics processor 406, an integrated circuit (not shown) that is capable of at least a portion of the capabilities of both the host processor 401 and the graphics processor 406, a chipset (i.e. a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 400 may take the form of a desktop computer, lap-top computer, and/or any other type of logic. Still yet, the system 400 may take the form of various other devices including, but not limited to, a personal digital assistant device, a mobile phone device, a television, etc.

Further, while not shown, the system 400 may be coupled to a network [e.g. a telecommunications network, local area network (LAN), wireless network, wide area network (WAN) such as the Internet, peer-to-peer network, cable network, etc.] for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
establishing a connection between an initiator and a drive;
determining the connection is a direct connection between the initiator and the drive; and
maintaining the established direct connection between the initiator and the drive, such that the established direct connection remains open for information transfer.

2. The method of claim 1, wherein the drive follows SCSI command protocol.

3. The method of claim 1, wherein the drive includes a Serial Attached SCSI (SAS) drive.

4. The method of claim 1, wherein the drive includes a Serial ATA (SATA) drive.

5. The method of claim 1, wherein the drive follows a protocol tunneled through SAS.

6. The method of claim 1, wherein determining the connection is a direct connection between the initiator and the drive includes utilizing identify frame data to determine the connection is a direct connection.

7. The method of claim 1, wherein determining the connection is a direct connection between the initiator and the drive includes utilizing a SCSI mode page to determine the connection is a direct connection.

8. The method of claim 1, wherein maintaining the established direct connection between the initiator and the drive is based on a mode.

9. The method of claim 8, wherein the mode is based on identify frame data.

10. The method of claim 8, wherein the mode is based on a SCSI mode page.

11. The method of claim 8, wherein the mode is a default mode.

12. The method of claim 8, wherein the mode is based on topology discovered.

13. The method of claim 1, wherein maintaining the established direct connection between the initiator and the drive includes establishing the connection such that at least one of timeouts associated with the connection are prohibited, timers are increased, or behavior is altered.

14. The method of claim 1, wherein maintaining the established direct connection between the initiator and the drive includes prohibiting a closing of the established direct connection.

15. The method of claim 1, wherein the drive and the initiator are positioned on a card.

16. The method of claim 15, wherein the card includes a PCI Express based card.

17. The method of claim 1, wherein the initiator establishes the connection between the initiator and the drive.

18. The method of claim 1, wherein the established direct connection remains open for information transfer between the initiator and the drive.

19. The method of claim 19, wherein the information includes at least one of data, commands, status, or control information.

20. A computer program product embodied on a computer readable medium, comprising:
computer code for establishing a connection between an initiator and a drive;
computer code for determining the connection is a direct connection between the initiator and the drive; and
computer code for maintaining the established direct connection between the initiator and the drive, such that the established direct connection remains open for information transfer.

21. An apparatus, comprising:
an initiator for establishing a connection between the initiator and a drive;
logic for determining the connection is a direct connection between the initiator and the drive; and
logic for maintaining the established direct connection between the initiator and the drive, such that the established direct connection remains open for information transfer.
